(19) United States
(12) Patent Application Publication
(10) Pub. No.: US 2013/0240362 A1
(43) Pub. Date: Sep. 19, 2013

(54) FLOW-THROUGH CONDENSER CELL FOR PURIFYING A FLUID

(71) Applicant: Tullio Servida, Milan (IT)

(72) Inventor: Tullio Servida, Milan (IT)

(73) Assignee: IDROPAN DELL'ORTO DEPURATORI S.R.L., Milan (IT)

(21) Appl. No.: 13/988,334

(22) PCT Filed: Nov. 18, 2011
(86) PCT No.: PCT/IB2011/002741

§ 371 Date: May 19, 2013

(30) Foreign Application Priority Data
Nov. 18, 2010 (IT) PD2010A000347

(51) Int. Cl. C02F 1/469

(52) U.S. Cl. CPC C02F 1/4691
USPC 204/661

(57) ABSTRACT

Flow-through condenser cell (1) for purifying a fluid containing ionized particles, which comprises a containment structure wherein a plurality of electrode layers (3) faced to each other and a plurality of spacer layers (4) interposed between the electrode layers (3) and susceptible of being passed through by a fluid flow containing ionized particles, whereby they are susceptible of being passed through perpendicular to the thickness thereof, are housed compressed. The cell further comprises compensation means for controlling the compression exerted by the containment structure on the layers.

### FIELD OF APPLICATION The present invention relates to a flow-through condenser cell for purifying a fluid, according to the preamble of the independent claim.

More in detail, the subject flow-through condenser cell is intended to be advantageously used in purification equipments for removing undesired concentrations of contaminants, for example consisting of salts dissolved therein, from fluids, and more in particular usually from liquids.

The subject cell may also be used in equipments adapted to concentrate ionized particles within fluids, in particular of industrial processes, for facilitating the recovery or disposal thereof.

The cell according to the present invention is therefore advantageously usable in purification equipments intended for multiple applications both in the industrial field and in the civil field, such as for example seawater desalination, softening of particularly hard waters, removal of salts (such as sulfates and chlorides), nitrates, nitrites, ammonia, heavy metals, organic substances or micro-pollutants in general, from water, or yet for fluid deionization for example in industrial processes, or for the concentration of polluting substances difficult to be disposed of or advantageous to be recovered for reuse.

The present invention, therefore, in general relates to the industrial field of production of equipment and equipment components for fluid treatment, filtering or purification.

### PRIOR ART

Equipment for purifying fluids by flow-through condensers traditionally comprises one or more cells, of the subject type of the present invention, connected in series or in parallel to one another.

Each cell is provided with a containment structure, usually made of plastic, and with a plurality of overlapped electrodes, which form the condensers, and are housed compressed within the containment structure.

The fluid flow to be treated is passed between the electrodes for obtaining, according to the applications, the concentration of a solute of ionized particles, that is, a solvent purified by such particles (either ions or other charged substances according to the specific application). The electrodes of flow-through condensers are formed with layers of conductive materials faced to each other and charged at opposite polarities by a direct current power supply for generating an electrostatic field between the contiguous electrodes.

During an expected service step of the cell, the fluid flows between the electrodes at different polarity and the charged particles present in the fluid, for example dissolved salt ions, are attracted by the electrodes and retained thereon by the electric field action.

In a regeneration step of the cell subsequent to the service step, the electric field is removed and the ions, which have accumulated on the electrodes, are discharged using an exhaust flow.

The operation of such cells therefore provides for the alternation of service steps, wherein the concentration of charged solutes takes place at the opposite electrodes, and regeneration steps, wherein the solutes accumulated on the electrodes are removed through said exhaust flow.

The electrodes of flow-through condensers absorb and electrostatically release the contaminants of ionic charges and actively participate in the deionization process of the liquid to be treated.

The removal of solutes through flow-through condenser cells does not substantially entails oxidation-reduction reactions and the current passage between the electrodes is mainly due to the charge yield subsequent to the contact of ions with the electrodes under the action of the electric field.

To this end, the electrodes are formed by porous structures of conductive materials. Several materials which may be used for making the electrodes are known, such as for example spongy activated carbon moulded in the shape of sheets or fibres as described for example in U.S. Pat. No. 6,413,409, i.e. sheets of a mixture comprising PTFE as described for example in U.S. Pat. No. 6,413,409.

Such porous structures allow considerably increasing the exchange surface of electric charges, and are often associated to graphite layers adapted for making the electrical connection with the power supply and imparting improved mechanical flexibility features to the same electrode.

According to the applications, filtering equipment may be required, with flow-through condensers provided with several cells for treating large volumes of fluid, i.e. for decreasing the conductivity of a fluid flow in multiple subsequent steps up to bringing it to desired values.

Each cell electrically behaves substantially as a large capacity condenser.

The alternating polarity electrode layers are separated from one another by spacer layers, wherein the fluid flow flows. Such spacer layers are made of a non-conductive and porous material such as for example a nylon fabric.

Flow-through condensers of the known type indicated above are for example described in U.S. Pat. Nos. 6,413,409 and 5,360,540.

In order to increase the performance of flow-through condenser cells, the surfaces of the electrode conductive layers have been associated to layers of permeable or semi-permeable material, capable of selectively trapping the ions that migrate towards the corresponding electrode under the action of the field, making membranes that selectively are of the anion-exchange type or of the cation-exchange type. The ions are thus retained or trapped within the material layer close to the electrode towards which they migrate, as they are not subject anymore to the whirling action of the fluid. The use of these materials has allowed improving the efficiency of flow condensers allowing a larger amount of ions and more in general, of charged contaminants, to be retained and concentrated on the electrodes.

In the practice, it has been seen that while the cells with ion-exchange membranes improve the performance of the previous cells without membranes, they exhibit the drawback of breaking quite frequently.

The manufacturers of flow-through condenser cells have attempted to obviate this drawback with increasingly resisting containment structures from the mechanical point of view, but with poor results, since at present the number of scraps, that is, of cells that are subject to breakage in operation, is still too large.

Moreover, the compression existing in the sequence of cell layers obtained with electrode layers and spacer layers, decreases the easiness of cell regeneration due to the difficulties that the fluid encounters to reach the electrodes, and in particular the pores or the carbon porous structure, for washing the ions or the salts collected or precipitated on the same electrodes.

Document U.S. Pat. No. 5,954,937 also describes a flow-through condenser cell for purifying a fluid, which comprises a containment structure and a plurality of electrode layers forming a sequence, faced to each other and housed within the containment structure.

An air gap is defined between each electrode and the next one of this sequence for the passage of a fluid to be purified. In particular, the electrodes in the sequence are parallel and overlapped and at the top and at the bottom they delimit the corresponding air gaps.

Moreover, each electrode has a passage hole for the fluid to be purified, for allowing the passage thereof between the air gaps.

In detail, the electrodes comprise a sheet, particularly of titanium, whereto a thin carbon aerogel layer is fixed, centrally on each face, capable of trapping ions that migrate towards the same electrode during the condenser cell operation.

This condenser cell further comprises a plurality of spacer layers, interposed between the electrode layers and that externally surround the thin layers without overlapping thereon.

These spacer layers keep the electrodes whereinbetween they are interposed spaced, and in particular they keep the thin layers of each electrode spaced from the thin layers of the adjacent electrode, so as to define, in each air space, an interstice between the thin layers of the corresponding adjacent electrodes.

Operatively, during the operation of said condenser cell, the fluid to be purified crosses in a sequence the air gaps between the electrodes, passing through the interstices through the thin layers which trap the ions that migrate through the electrodes.

In more detail, the subject spacer layers are sealing gaskets that externally delimit said air gaps for preventing the fluid escape from the air gaps. To this end, the electrodes are held pressed against the spacer layers through tie rods that cross all the electrodes and the spacer layers, pressing them one onto the other.

In this condenser cell, therefore, each thin layer is free from the spacer layers, which do not cover it, and therefore it can freely expand within the air gap subsequent to the ion trapping, without generating a spreading thrust of the electrodes.

A drawback of this condenser cell consists in the fact that during the operation of the cell, the thin layers tend to expand by the effect of the ion absorption from the fluid flow to be purified, by expanding, the thin layers reduce the interstice defined thereinbetween, consequently hindering the fluid passage thereinbetween.

The international application WO2008/016671, moreover, discloses a water purification device that comprises a porous anode electrode and a porous cathode electrode, each made of graphite, at least one metal oxide, an ion-exchange polarizable polymer and is optionally provided with micro-channels.

An electrically insulating and permeable spacer layer is arranged between the electrodes, which has the function of electrically insulating the electrodes.

Wastewater is susceptible of flowing through the thickness of the electrodes and of the spacer layer, from one electrode to the other electrode, for being filtered by the same electrodes that trap ions of organic or inorganic substances, such as metal ions, and retain non-ionic impurities such as non-ionic organic materials or bacteria.

The electrodes and the spacer layer are arranged within a housing provided with a wastewater inlet opening, an exhaust waste outlet opening and a purified water outlet opening. In this way, the system components are easily replaced in case of need.

The US patent publication no. US2008/297980 discloses carbon electrodes, for example for the capacitive deionization (CDT) of a fluid flow or in an electric double layer capacitor

(EDLC). Such carbon electrodes comprise an electrically conductive support of porous carbon and a covering layer consisting of carbon particles in contact with the electrically conductive support.

The electrically conductive support comprises a carbonizable material that forms a bond with the carbon particles at the level of the interface between the electrically conductive support and the covering carbon layer. In some embodiments, the electrically conductive support has a layered structure, wherein one of the layers is a carbonizable paste layer comprising electrically conductive particles.

The international application publication no. WO00/14304 discloses a flow-through condenser and a method for treating fluids through such condenser.

In particular, such condenser comprises a separator, electrodes and a collected piled up in a multi-layer with serial arrangement [3/2/1/2] sub n/3 and each consisting of a polygonal sheet provided with a substantially central through hole for the passage of a liquid.

The above-mentioned multi-layer is seated in a housing which is provided with a cover and with a bottom whereinbetween the multi-layer is arranged, and which are mechanically connected by tie rods that cross the same multi-layer.

The multi-layer may be compressed by actuating the tie rods that tighten the cover and the bottom on the multi-layer. The liquid to be treated is made to pass through the condenser by an inlet and an outlet obtained in the housing.

### DISCLOSURE OF THE INVENTION

In this situation, therefore, the problem underlying the present invention is to eliminate the drawbacks of the above-mentioned prior art by providing a flow-through condenser cell for purifying a fluid, which should greatly reduce the failures by breakage of the containment structure during the operation thereof.

Another object of the present invention is to provide a flow-through condenser cell for purifying a fluid which is constructively simple and inexpensive to make and totally operatively reliable.

Another object of the present invention is to provide a flow-through condenser cell for purifying a fluid which has a high performance.

### BRIEF DESCRIPTION OF THE DRAWINGS

The technical features of the finding, according to the above objects, are clearly found in the contents of the claims below and the advantages of the same will appear more clearly from the following detailed description, made with reference to the annexed drawings, which show purely exemplary and non-limiting embodiments thereof, wherein:

FIG. 1 schematically shows a detail of the flow-through condenser cell for purifying a fluid object of the present invention relating to a cutaway portion of the layers that make up the flow-through condenser;

FIG. 2 schematically shows a first embodiment of the subject cell of the present invention with exploded parts thereof and with some parts removed or cutaway to better show other ones;

FIG. 3 schematically shows a cutaway view of a second embodiment of the subject cell of the present invention, with some parts removed to better show other ones;

FIG. 4 schematically shows a cutaway view of a third embodiment of the subject cell of the present invention, with some parts removed to better show other ones.

### DETAILED DESCRIPTION OF A PREFERRED EMBODIMENT

With reference to the annexed drawings, reference numeral 1 globally indicates an exemplary flow-through condenser cell according to the present invention, adapted to be used in an equipment for purifying a fluid from contaminants.

More clearly, the subject cell I is suitable for being used in equipments for purifying fluids from ionized particles, present therein, susceptible of being affected by the presence of an electric field, such as for example ions in solution.

In the following description, the term ionized particles shall generally indicate any contaminant dissolved in the fluid to be treated capable of being attracted by an electrostatic field, such as in particular ions dissolved in a solution.

Cell 1 is therefore suitable for being used for the deionization of fluids of industrial processes and for the deionization of water, in particular for the desalination of seawater, in particular being capable of removing salts in solutions (such as sulfates and chlorides), nitrates, nitrites, ammonia, and other polarized contaminants of organic substances or micro-pollutants in general, from therein.

In the exemplary embodiment shown in the annexed figures, cell 1 for purifying a fluid comprises a flow-through condenser formed, in a per se known manner, by a plurality of electrode layers 3 electrically connected, by special collectors (not shown), to a direct current power supply DC. The latter charges the contiguous electrode layers 3 at different polarity so as to define a plurality of electrode pairs faced to each other that form the reinforcements of an equivalent number of condensers in a series whereinbetween the electric fields are established.

The electrode layers 3 are for example charged to a voltage of 1.6 Volts and they are obtained with overlapped and facing layers of conductive material, separated from each other by spacer layers 4 wherein the fluid flow to be treated, containing the ionized particles that are to be at least partly removed, flows.

In particular, the electrode layers 3 and spacer layers 4 are advantageously overlapped on each other and form a sequence of electrode layers 3 alternating with spacer layers. The spacer layers 4 are susceptible of being passed through by a fluid flow containing ionized particles whereby they are susceptible of being passed through perpendicularly to the thickness whereof.

Operatively, during the operation of cell 1, such fluid flow flows within each spacer layer 4, perpendicular to the thickness of the latter, so that it touches the faces of the two electrodes 3 whereinbetween this spacer layer 4 is interposed.

The conductive layers forming electrodes 3 are made of a material with a porous structure, that is, with a formation of surface interstitial pores that offer a considerable exchange surface with the liquid.

The material which conductive layers 3 are made of may be any material notoriously used in the electro-chemical processes of flow condensers and shall traditionally comprise spongy activated carbon, or it may consist of any of the materials described for example in U.S. Pat. No. 6,413,409, annexed hereto as a reference, from line 64 of column 3 to line 41 of column 4, or of flexible conductive PTFE sheets and carbon particles, as described in U.S. Pat. No. 7,175,783, annexed hereto as a reference, or yet of any material described in U.S. Pat. No. 6,709,560, annexed hereto as a reference, from line 26 of column 6 to line 23 of column 7.

Preferably, the conductive layers 3 are made of a graphite sublayer 3′ and of an activated carbon sublayer 3″ coupled to each other, and whereof the graphite sublayer 3′ is intended for making an electrical connection with the power supply, and the activated carbon. sublayer 3″ is intended for increasing the current exchange area with the ions or charged particles present in the fluid.

The spacer layers 4 may in turn be made for example of highly porous non conductive materials, capable of insulating the electrodes allowing the fluid flow passage, such as for example a porous synthetic material or other materials of non conductive spacer materials such as fiberglass or a nylon fabric.

Dimensions, shape and distribution of the conductive material layers making up the electrode layers 3, or dimensions, shape and distribution of the spacer material layers interposed between the electrodes are not an object of specific claim and shall not be described in detail as they are well known to a man skilled in the art and merely by way of an example described in U.S. Pat. No. 6,413,409 or in U.S. Pat. No. 6,709,560, hereto annexed by reference, in particular from line 11 to line 23 of column 7.

The electrode layers 3 further comprise an ion-exchange semi-permeable material layer 31, which may be associated in various manners to the conductive material layer 3. More in detail, such layer 31 may be separated from the conductive material layer 3 or overlapped as a coating thereof, or yet infiltrated within the pores thereof or consisting of the same conductive material layer 3, as described for example in U.S. Pat. No. 6,709,560, hereto annexed as a reference, from line 27 of column 6 to line 10 of column 7, having similar selective ion-exchange behaviour, and hereinafter referred to with the same terminology of ion-exchange semi-permeable material layer 31.

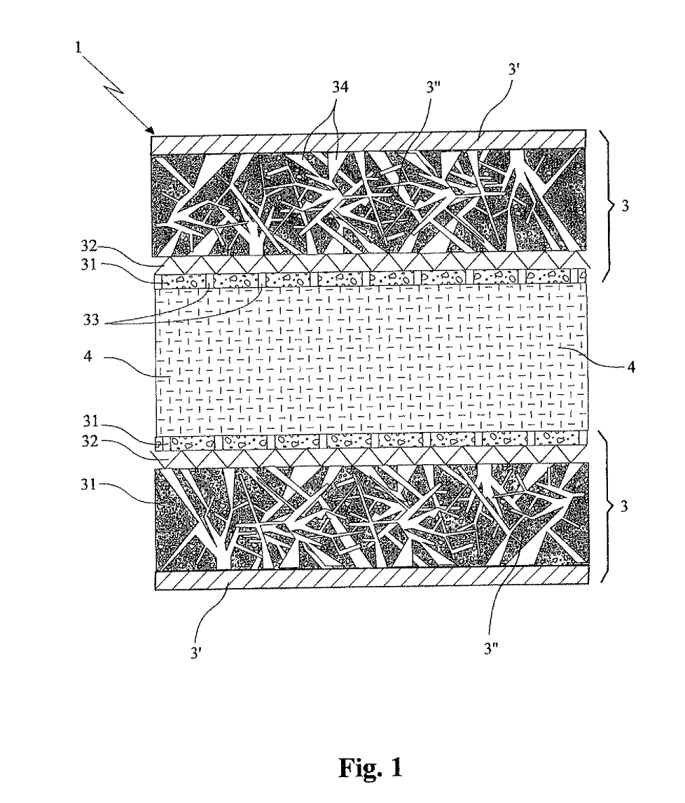

According to the example shown in FIG. 1, the semi-permeable material layer 31 is separate from the surface of electrode 3 by a spacer 32.

Such further semi-permeable material layer 31 may be obtained with a semi-permeable membrane or with one or more charged material layers, as described for example in U.S. Pat. No. 6,709,560, hereto annexed as a reference also from line 50 of column 4 to line 10 of column 7.

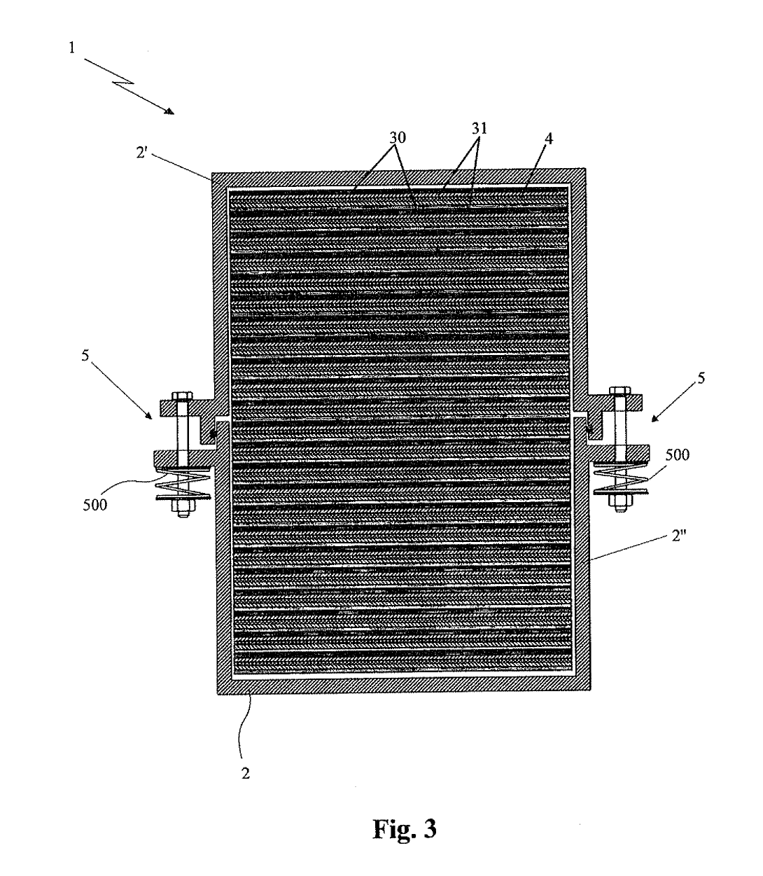

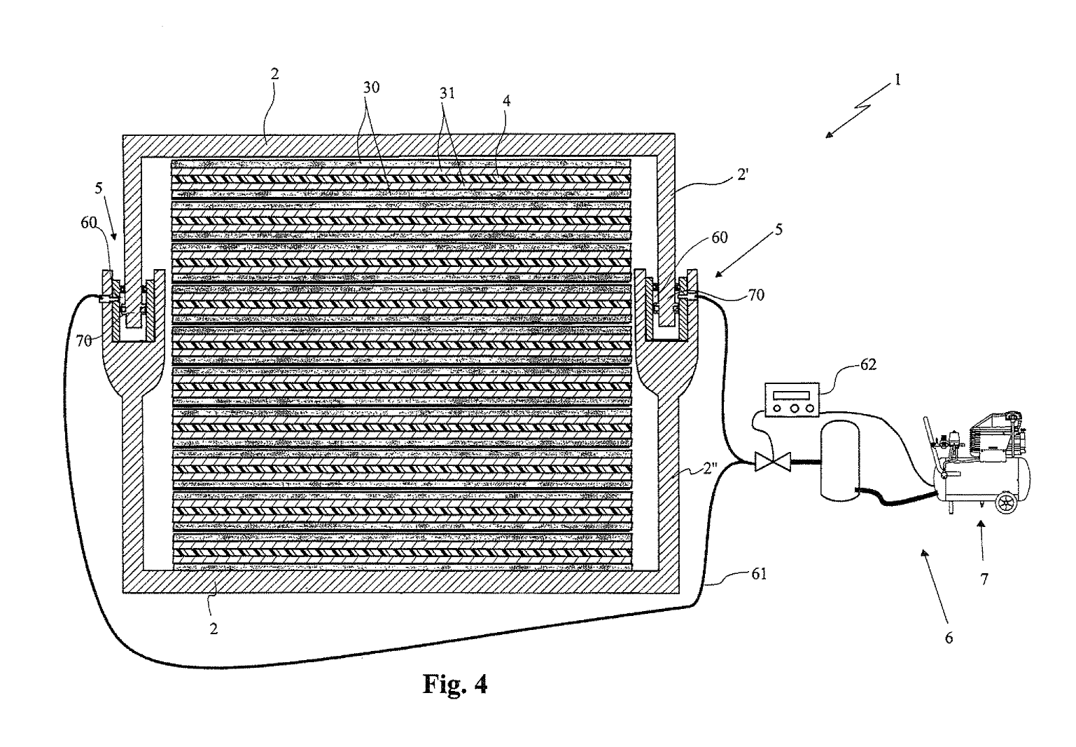

The semi-permeable material layer 31 is adapted to selectively trap the ions that migrate towards electrodes 3 under the action of the field during a service step, better detailed hereinafter, allowing the performance of the condenser to be improved, that is, retaining a larger amount of charged particles in said service step. These last mentioned are then at least partly released by electrodes 3 during the subsequent regeneration step, in particular passing through provided holes 33 obtained in the semi-permeable material layer 31. In FIGS. 3 and 4, for simplicity of understanding, the graphite sublayer 3′ and the carbon sublayer 3″ of electrodes 3 have been globally indicated with reference numeral 30.

Cell 1 is delimited in a per se traditional manner by a containment structure 2, usually consisting of a box body of plastic material, wherein the sequence of electrode layers 3 and of spacer layers 4 are housed compressed.

Cell 1 is intended for being fed, during the operation of the purification equipment it is integrated in, with a fluid flow through a feeding conduit. The fluid flow passing through the condenser of cell 1 is therefore conveyed in output to an extraction conduit. To this end, the containment structure 2 of cell 1 is provided with a special inlet opening, connected to the feeding conduit, and with a special outlet opening, connected to the extraction conduit.

The flow-through condenser of cell 1 is electrically connected to a direct current power supply provided with an integrated circuit control board, which, in the various operating steps of the operating cycle of the condenser, controls the voltage applied to the electrodes by special connecting collectors, typically by semiconductor switches.

The operating cycle of cell 1, in a per se known fully traditional manner and well known by the man skilled in the art, provides for a charging step wherein the power supply charges the contiguous electrodes 3 at a different polarity for bringing them to a constant operating voltage and, for example, equal to 1.6 V. The cycle then provides for a service step, wherein with the charged electrodes, the fluid flow to be treated is forced to pass through the condenser, by the feeding conduit and the extraction conduit. The fluid depuration from the polarized particles takes place during such service step, due to the fact that the ionized particles are attracted by the respective electrodes at an opposite polarity causing a progressive accumulation of the same ionized particles on the same electrodes.

Once the scheduled saturation of the electrodes with the polarized particles present in the fluid has been reached, the cycle provides for a regeneration step wherein with electrodes 3 deactivated, a discharge fluid flow, preferably containing a solubilizing product, is forced to pass in the condenser with consequent removal of the ionized particles accumulated on electrodes 3.

The term “solubilizing product” is meant to refer to any product, advantageously in particular available in a solution for easiness of introduction in the condenser, capable of increasing the solubility of the specific ionized particles it is intended to interact with in the planned application, increasing the precipitation threshold thereof. Therefore, it shall for example consist of a solution containing a counter ion capable of inhibiting, within certain limits, the precipitation of the ion contained in the fluid to be treated and thus, for example, it may consist of an acid solution for the solubilization of carbonates or nitrates.

Usually, the exhaust flow that passes within cell 1 during the regeneration step has to be considered as waste (unless the purpose of the equipment is to concentrate a solution) and, if it is equipment for water deionization, it shall be sent to the normal exhaust provided in the hydraulic system.

A pre-production step may also be carried out before resuming the service step, wherein the fluid flow to be treated continues to be conveyed to the exhaust waiting for the condenser to reach the charge at the planned voltage and thus electrodes 3 are fully efficient for their action of depuration of the liquid from the ionized particles.

The term “deactivated” means all those conditions electrodes 3 are subjected to before resuming the charging step and that generally provide for a discharge step with short-circuiting of electrodes 3, a positive discharge step wherein electrodes 3 are subjected to a reverse polarity voltage aimed to move the charged particles away from electrodes 3, wherein they had accumulated, and a no voltage step prior to resuming the charging step.

A master CPU logical control unit actuates the different operating steps of equipment 1 wherein one or more cells object of the present invention are integrated.

According to the idea at the basis of the present invention, cell 1 further comprises compensation means 5 for controlling the compression exerted by the containment structure 2 on layers 3, 4.

The idea at the basis of the present invention originates from the search and definition of the problem at the basis of the breakage of the containment structures 2 according to the prior art to date, and from the surprising solution to the problem.

The electrode layers 3 vary their volume according to the ionic form they take, in particular according to the presence of the ion-exchange membrane layers 31. For example, the cation-exchange membranes 31, when working in the form of calcium (that is, in a solution rich in calcium) have a quite contracted shape, due to the small dimensions of calcium ions.

Likewise, when the cell treats seawater, the cation membranes are found in the form of sodium, that is, in any case in a quite contracted form. On the other hand, when the same membranes 31 are subjected, during the normal operating cycle thereof, to the scheduled regeneration steps by a solubilizing product, such as for example an acid solution, they are usually found in the form of hydrogen, i.e. with the functional groups thereof (for example SO₃) bound to hydrogen ions that greatly increase the dimensions thereof. Therefore, according to the environment in which the semi-permeable membrane 31 works, considerable variations in the volume thereof may be observed. For example, a 10% variation for a 300 μm thick membrane implies that with 100 electrode pairs there is a thickness variation equal to 3 mm. Since layers 3, 4 of cell 1 are already per se usually compressed in order to improve the electrical conductivity of the electrode layers 3, that is, in particular to improve the conductivity between the carbon sublayer 3″ and the graphite sublayer 3′, a significant increase in the thickness of membranes 31 is capable of causing an excessive compression of layers 3, 4 and the exceeding of a maximum pressure threshold value with a degradation of the efficiency of cell 1, or with a breakage of the containment structure 2 thereof.

In the presence of compression, besides a limit threshold value, the deformations of the electrode layers 3 may become irreversible so that as the sequence of layers 3, 4 does not return to the design dimensions anymore, it is not capable of allowing cell 1 to work with optimal performance, that is, with a satisfactory flow rate of the fluid passing through the same cell 1.

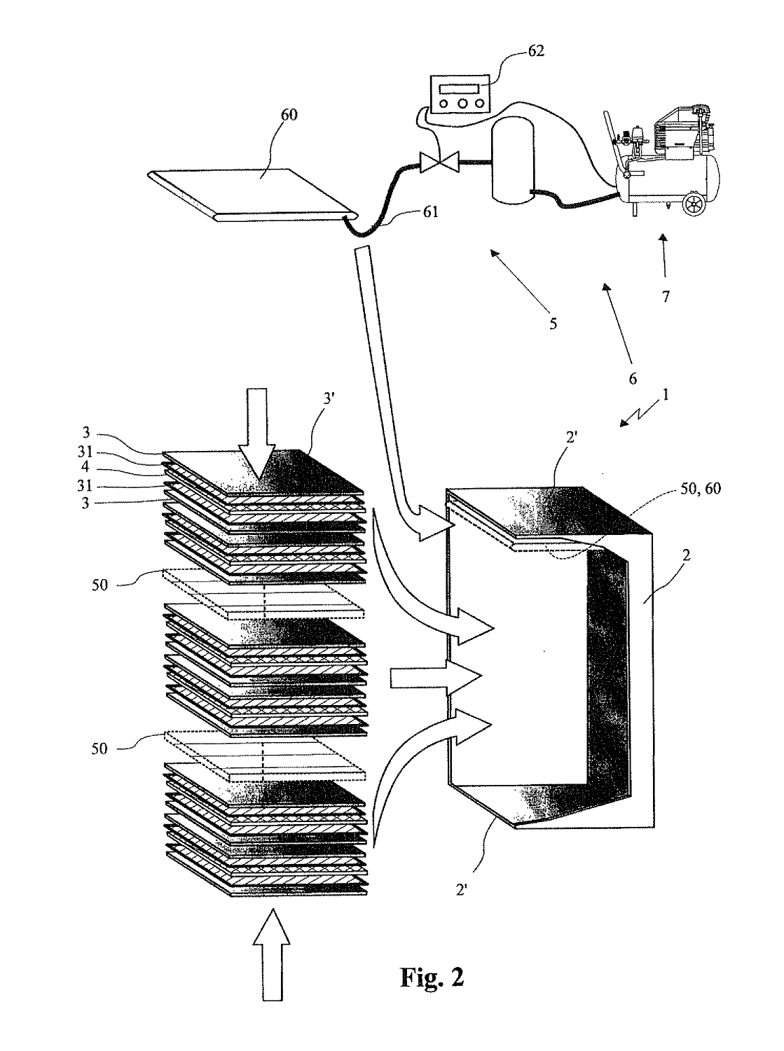

According to the embodiment shown in FIG. 2, the compensation means 5 comprise a shock-absorbing material layer 50, acting on at least one layer of the sequence of layers 3, 4, whereof preferably the shock-absorbing material layer 50 covers at least one face, for acting on this face in a substantially even manner. It is represented with a dashed line in FIG. 2 interposed between layers 3, 4 of cell 1.

Preferably, such shock-absorbing layer 50 shall be positioned between at least one end wall 2′ of the containment structure 2 of cell 1 (that is, on the bottom wall or on the top wall in the development direction of the sequence of layers 3, 4) and at least the corresponding end layer 3′ of the sequence of layers 3, 4, whereof it preferably covers an entire face.

Differently, one or more shock-absorbing material layers 50 may be interposed between the layers of the sequence of layers 3, 4 for example at predetermined intervals between two contiguous electrode layers 3, whereof they advantageously cover a face.

Advantageously, the shock-absorbing material layer may be obtained from a polymeric material, such as for example a rubber or a foam material, preferably with closed cells.

The shock-absorbing material layer 50 may also be obtained with a pad provided with elastically yielding means for allowing the development of an elastic reaction to the variable compression of layers 3, 4.

The compensation means 5, and in particular the shock-absorbing material layer 50 described above may in particular be obtained by a sealing body 60 defining an air chamber. Such sealing body 60 may for example be in the form of a pad acting on the sequence of layers 3, 4 and positioned, as already indicated above with reference to the shock-absorbing material layer, for example interposed between an end wall 2′ of the containment structure 2 and an end layer 3′ of the sequence of layers 3, 4.

According to a different embodiment of the present invention shown in FIG. 3, the containment structure 2 is obtained in at least two parts 2′, 2″ connected to each other for defining the containment space of the sequence of layers 3, 4. The two parts, for example shaped as a shell, are slidingly mounted on top of each other being mechanically retained by the compensation means 5.

These last mentioned may advantageously be obtained with one or more elastically yielding elements, such as for example simple springs 500 as shown in FIG. 3.

The sequence of layers is shown in the annexed figures as an overlapping of flat and parallel layers. Differently, the sequence of layers 3, 4 may be obtained by winding spiral-wise, preferably starting from a central core, layers 3, 4 as for example indicated in U.S. Pat. No. 5,60,597 FIG. 5 from column 9 line 65 to column 10 line 6; U.S. Pat. No. 5,192,432 FIGS. 1 and 2 and column 6 lines 5-47; U.S. Pat. No. 5,748,437 FIGS. 13, 14 from column 12 line 48 to column 13 line 13.

What indicated above with reference to the sequence of flat layers may be easily adapted, mutatis mutandis, also for a spiral-wise distribution of layers wherein in any case a sequence of compressed layers 3, 4 is radially obtained, susceptible of breaking the provided outer tubular, and in particular cylindrical, containment structure by an increase in volume. Preferably, according to this last mentioned embodiment, the compensation means shall be provided at the central core, between two contiguous layers or close to the outer cylindrical containment structure.

According to an advantageous feature of the present invention, cell 1 further comprises adjustment means 5 adapted to act on the compensation means 5 for varying the compression exerted by the containment structure 2 on layers 3, 4.

Such adjustment means 6 advantageously are pneumatic, i.e. obtained with a controlled supply source 7 of pressurized air connected to the sealing body 60 of the compensation means 5 by at least one conduit 61. A logical control unit 62 not shown in detail as it clearly is within the reach of any man skilled in the art, may control, advantageously through valves, the feeding and the exhaust of the sealing body 60 for varying the pressure exerted by the latter on the sequence of layers 3, 4 of cell 1.

In the case of spiral winding of the layers, the sealing body 60 of the compensation means 5 may be obtained with a tubular conduit arranged at the cores of the winding of the layers in contact with the first layer of the sequence of layers.

The air sealing body 60 may be in the form of an operating chamber of a pneumatic piston 70 interposed between the movable parts 2′, 2″ of the support structure 2 of cell 1. The thrust opposing the action of piston 70 shall be given by the sequence of layers 3, 4 in compression in cell 1 and optionally it may be aided by the thrust of elastic means, not shown.

By the means 6 for adjusting the pressure present between layers 3, 4 it is possible to vary the compression existing between the layers in the different operating steps of cell 1. In particular, it is possible to diversify the compression of the service step relative to the compression of the regeneration step. Advantageously, it is possible to provide for a lower pressure for this latter step so as to allow the exhaust (or washing) fluid to reach the electrode layers and in particular the interstitial pores of the activated carbon sublayers 3″ more easily, especially if the ion-exchange membranes 31 are provided.

In this case, in fact, a decreased pressure shall allow the washing fluid to pass between the ion-exchange membrane 31 and the spongy carbon layer 3″, washing the interstitial pores of the latter.

A variation in the pressure of layers 3, 4 of cell 1 may further be provided, to a certain extent, for adjusting the fluid passage flow rate in the service step and thus for varying the fluid flow rate treated by cell 1. A greater compression, in fact, causes a narrowing of the thickness of the spacer layers 4 wherein the fluid to be treated passes, whereas on the other hand, a lower pressure causes an expansion of such spacer layers 4 and thus an increase in the fluid rate to be treated.

The term “interstitial pores” indicates all the pores, micropores, or holes present in electrodes 3 i.e. in the layers making up electrodes 3 such as the conductive material and semi-permeable material layers 31. In the embodiment example shown in FIG. 1, they have been indicated with reference numeral 34 with reference to the pores of the conductive material and semi-permeable material layers 31, and with reference numeral 33 with reference to the holes, of a size larger than pores 34, obtained on the semi-permeable material layer 31.

The cell thus conceived thus achieves the intended purposes.

Of course, in the practical embodiment thereof, it may take shapes and configurations differing from that illustrated above without departing from the present scope of protection.

Moreover, all the details may be replaced by technically equivalent ones and the sizes, shapes and materials used may be whatever according to the requirements.

1. Flow-through condenser cell for purifying a fluid, which comprises:
a containment structure;
a plurality of electrode layers faced to each other;
a plurality of spacer layers susceptible of being passed through by a fluid flow containing ionized particles and susceptible of being passed through by the flow of said fluid perpendicular to the thickness thereof, said spacer layers being interposed between said electrode layers and forming a sequence of layers with them; the layers of said sequence being housed compressed within said containment structure;
characterized in that it comprises compensation means to control the compression exerted by said containment structure on said layers.

2. Flow-through condenser cell for purifying a fluid, according to claim 1, characterized in that each of said electrode layers comprises at least one ion-exchange membrane.

3. Flow-through condenser cell for purifying a fluid, according to claim 1, characterized in that said compensation means comprise at least a shock-absorbing material layer, acting on at least one of said layers of said sequence of layers.

4. Flow-through condenser cell for purifying a fluid, according to claim 3, characterized in that said shock absorbing material layer is made of polymeric material, in particular of closed cell foam material.

5. Flow-through condenser cell for purifying a fluid, according to claim 1, characterized in that said compensation means comprise a sealing body defining an air chamber.

6. Flow-through condenser cell for purifying a fluid, according to claim 5, characterized in that said sealing body is shaped as a pad acting on said sequence of layers, in particular on at least one of said layers of said sequence of layers.

7. Flow-through condenser cell for purifying a fluid, according to claim 6, characterized in that said pad is interposed between an end wall of said containment structure and an end layer of said sequence of layers.

8. Flow-through condenser cell for purifying a fluid, according to claim 1 characterized in that it comprises adjustment means adapted to act on said compensation means to vary the compression exerted by said containment structure on said layers.

9. Flow-through condenser cell for purifying a fluid, according to claim 5, characterized in that:
said compensation means comprise a sealing body defining an air chamber and
said adjustment means comprise a controlled supply of pressurized air, which is connected to said sealing body to adjust the compression exerted by said containment structure on said layers.

10. Flow-through condenser cell for purifying a fluid, according to claim 1, characterized in that said containment structure comprises at least two parts slidably movable with each other, said compensation means being interposed between them.

11. Flow-through condenser cell for purifying a fluid, according to claim 5, characterized in that:
said compensation means comprise a sealing body defining an air chamber and
said sealing body is an operation chamber of a pneumatic piston interposed between said two movable parts of said support structure.

12. Flow-through condenser cell for purifying a fluid, according to claim 1 characterized in that said compensation means comprise at least an elastically yielding member.

13. Flow-through condenser cell for purifying a fluid, according to claim 3, characterized in that said at least one shock-absorbing material layer covers a face of at least one layer of said sequence of layers.
